(19) United States
(12) Patent Application Publication
(10) Pub. No.: US 2024/0158145 A1
(43) Pub. Date: May 16, 2024

(54) TAMPER-EVIDENT CLOSURE SYSTEM WITH METALLIC CONTAINER AND PLASTIC CLOSURE

(71) Applicant: Rieke LLC, Auburn, IN (US)

(72) Inventor: Ronald KIERAS, McHenry, IL (US)

(21) Appl. No.: 18/510,809

(22) Filed: Nov. 16, 2023

Related U.S. Application Data
(60) Provisional application No. 63/425,778, filed on Nov. 16, 2022.

(51) Int. Cl. B65D 51/22; B44D 3/12; B65D 43/02

(52) U.S. Cl. CPC B65D 51/228; B44D 3/127; B65D 43/0212; B65D 43/0285; B65D 2251/0018; B65D 2251/0081; B65D 2543/00092; B65D 2543/00277; B65D 2543/00296; B65D 2543/00314; B65D 2543/00472; B65D 2543/0074; B65D 2543/00796

(57) ABSTRACT

A closure system can be attached to existing paint pails, cans, and other, similar metallic containers. It includes a crimped insert ring attaching to the container and a primary lid, preferably having tamper-evident features. A secondary lid is seated on and seals to the primary lid, with the secondary lid possibly being made partially or completely from plastics, thereby facilitating its ability to reseal the paint container by way of a plug seal. The insert, primary lid, and secondary lid may have one or more annular grooves or ridges to facilitate their attachment to one another.

### CROSS REFERENCE TO RELATED APPLICATIONS

This application claims priority to U.S. provisional patent application No. 63/425,778 filed on Nov. 16, 2022, which is incorporated by reference herein.

### TECHNICAL FIELD

The present invention relates to a closure system attachable to wide-mouthed containers and, more specifically, a system for use with paint containers having a tamper-evident primary lid attachable to conventional paint containers by a specially formed crimp ring insert and a friction-fitting secondary lid made of plastic and/or metal attachable to a concentric portion of the primary lid.

### BACKGROUND

Metallic paint containers have been in use for decades. One conventional design for forming closures on such containers involves crimping or curling the metallic sidewalls around a top panel and/or a around an annular ring or insert which itself connects to that top panel. Often times, these closures are necessarily formed from metal so as to accommodate the crimping process. Generally speaking, many of these systems rely on fitting an insert over the top, open edge of a container or pail. In some disclosures, the insert is crimped or captured via “curling” the metal container edge. A cap may be applied to or integrated with the closure.

One example of a typical “rim seal” style metallic container can be found in U.S. Pat. No. 5,161,689. Here, a plastic annulus is fitted over the conventional method of closing a paint container to facilitate stacking of multiple containers. The annulus snap fits over a retaining ring that is crimped onto the terminal edge of the container. The ring has a radial extension that includes a groove sized to receive a corresponding feature formed on an outer edge of a sealing lid. The sealing lid can be force fitted or removed from the groove (and the container/ring), usually be way of a screwdriver, crowbar, or similar tool. Generally speaking, this type of rim-seal arrangement relies on metallic components owing to their durability.

Another iteration for paint container closure can be found in U.S. Pat. No. 9,718,301, in which a pliable, plastic lid with dimples on its periphery that are attachable to corresponding apertures formed on the inner rim of the container. U.S. Pat. No. 7,137,525 contemplates integral features on the panel of a plastic lid (sealed to a plastic pail) to accommodate storage of paint brushes and rollers.

Separately, it is known that plastic closures on industrial drums can be manufactured to include tamper evident (TE) features. Generally speaking, a single-use frangible element may be formed on and/or fitted over the closure opening, such as by way of strip that is physically removed or a ring that separates when the lid is first removed. For example, U.S. Pat. No. 7,607,551, in which a plug seal for a container includes a removable panel having a bail handle. U.S. Pat. Nos. 4,534,481; 5,996,833; 6,360,908; 7,080,747; 7,537,132; and 7,568,585 provide further examples of TE arrangements.

All of the aforementioned patent documents are incorporated by reference. Further, to the extent compatible with the description below, further aspects of the invention may incorporate one or combinations of the features found in these conventional designs.

In view of these earlier examples, a closure system that coupled the familiarity of a metallic rim-seal closure with the advantages of plastic lids (e.g., for tamper evidence) would be welcomed. Additionally or alternatively, a closure system that is durable, reusable, and can be implemented with existing containers and manufacturing lines (i.e., current metallic-only closure systems) without modification is needed.

### SUMMARY

A closure system for conventional paint containers is contemplated. The system includes a metallic ring insert that is crimped or otherwise attached to the edge of a conventional paint container. A primary lid is simultaneously or subsequently crimped or attached to the curled flange holding the container to the crimp ring. A second lid made of plastic or metal is than coupled to the top facing of the primary lid. The crimp ring, the primary lid, and the secondary lid all have contoured surfaces including one or more annular grooves and/or ridges, all of which are positioned and aligned to enable the primary lid and the crimp ring and, separately, the secondary lid and the primary lid to couple to one another. In the latter case, the secondary lid can be releasably held so that the paint container can be resealed. The primary lid may also be imparted with a tamper evident feature, such as a one-time removable pull-seal. In some aspects the tamper evident feature is overmolded onto a metallic ring, which is then crimped to the container.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1 is an exploded, cross sectional perspective view of a portion of the paint container and closure system according to various aspects of the inventive system, with the secondary lid removed from the primary lid.

FIG. 2 is an exploded, one quarter cross-sectional side view of the container and system shown in FIG. 1, with the arrow showing how the secondary lid is fitting/coupled to the primary lid.

FIG. 3 is a perspective view of the system with the secondary lid omitted and a portion of the tamper-evident feature on the primary lid peeled away/partially removed.

FIG. 4 shows schematic, full and partial cross sectional views of alternative arrangements for a composite secondary lid or tertiary overcap made from plastic or plastic overmolded around metallic components, all of which highlight the possibility of forming a plug-style sealing flange on an underside of the secondary lid to couple and seal the secondary lid/overcap to the primary lid (not shown).

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

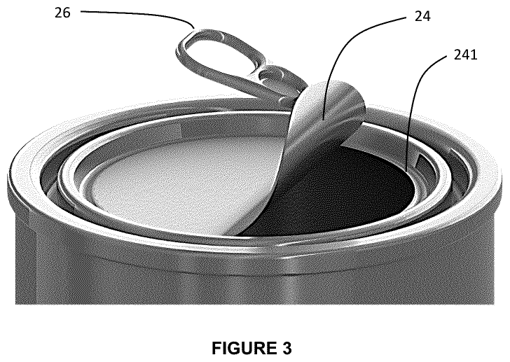

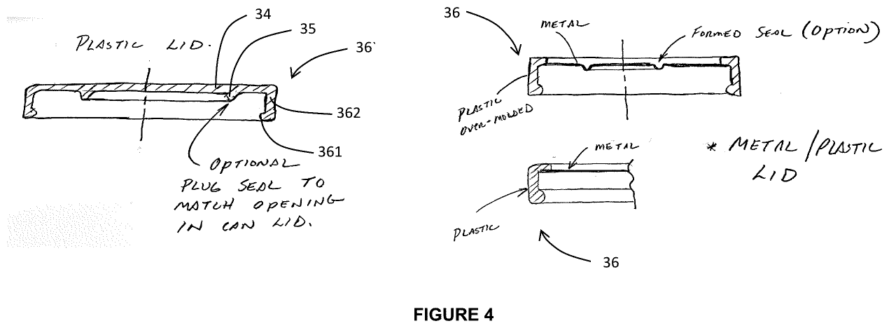

Insofar as the container and/or selected components described herein may possess a an elongated cylindrical shape, it will be understood that the terms length, axis, and axial may be used synonymously, while transverse, radial, and diameter all refer to lines and spatial planes that are perpendicular to the length. Otherwise, reference to vertical and horizontal will be understood based upon the top of the page and the bottom of the page (in “portrait” orientation for FIGS. 1-3 and in landscape orientation for FIG. 4) for each of the images in the attached drawings.

Also, unless otherwise stated, measurements and observations were taken under normal, ambient conditions (e.g., temperature, pressure, etc.), and any molecular weights are weight averages while formulations can be presumed as weight percentages (if/when appropriate). Still other terminology, conditions, and measurement techniques/methodologies will be readily apparent to those skilled in this art based upon industry norms, and this disclosure should be interpreted accordingly, and a skilled person will be well versed in applicable ASTM standards and procedures even if they are not expressly identified herein.

With reference to FIGS. 1 through 4, various aspects and views of the closure system are provided (as described above). The various implementations of the closure system may be combined, and these separate views should not be considered as limited.

Generally speaking, the system includes a crimp ring 10 that is attached to the paint container 5 by curling the edge 111 in “beverage can” style or similar fashion. The ring 10 is preferably metal, and is configured to receive and retain a primary lid 20.

In some aspects, the crimp ring 10 will have an upwardly curled edge 13 on its inner periphery. This curled edges 11, 13 extend axially so that the inner and outer portions of the crimp ring have approximately the same elevation at axis A (which extends along the same plane as the cross sectional view in FIG. 1, and all of the axes A, B, C, and D refer to the permanently affixed axial positioning of the ring 10 and primary lid 20 relative to the container 5). The inner and outer axial elevations conform to cooperating feature on the primary lid 20 to improve the coupling, as will be described below. It may be possible to curl the inner peripheral edge downward, so long as the elevation at the top facing of the crimp ring remains comparable to the top facing along its outer peripheral edge.

On its outer periphery, out edge of radial ledge 11 is formed into a beverage can-style connection in which edge 111 is folded around a bent terminal edge of the container, thereby imparting a G-shape to the outer edge of the crimp ring, with the terminal edge of the container wall 5 captured or sandwiched in between, and the outer periphery of portion 11 presents sufficient radial surface area on the crimp ring to allow for the crimping of its outer periphery. Portion 11 is aligned along axis B, which is positioned beneath axis A

An annular groove 12 is disposed between the inner and outer edges of the crimp ring 10. This groove 12 may have a U-shape that is configured to conform, receive, and hold (via friction fit) a corresponding feature 22 on the primary lid 20 by aligning along axis D that defines the lower-most end of the closure system. In some aspects, this feature may include a ridge in addition to or in place of the annular groove. In any instance, it is important to ensure that the coupling feature 12 on the crimp ring 10 is configured to cooperate with corresponding features 22 on the primary lid 20 (also note that the secondary lid 30 may also cooperate with feature 22 on the opposite facing of the primary lid, for purposes of sealing and/or positioning).

A primary lid 20 has a cooperating shape in comparison to the crimp ring 10 (e.g., circular). Notably, the primary lid 20 must have a larger diameter than the crimp ring 10, as the outer peripheral edge 211 of the primary lid is bent, crimped, or snap-fitted around the style coupling between the crimp ring 10 and the container 5 (i.e., at curled edge 111). This creates an axial skirt 212 that encases the crimped connection between the ring 10 and the container 5, while the concentric portions of the primary lid (at least initially) conceal and seal the interior volume of the container 5.

In some aspects, the very edge of the primary lid 211 may be curled under the G-shape of the crimp ring 10 so as to permanently secure the primary lid 20 to the crimp ring 10. When finally installed, the crimp ring 10 and the primary lid 20 will remain affixed to the container, and a user only needs to rely on the tamper evident feature of the primary lid and, subsequently, use of the secondary lid to reseal the container after it is first opened.

The primary lid 20 will have a cooperating annular groove 22 (or coupling feature) immediately adjacent to the peripheral section 21 that fits over the crimp ring/container joint. As noted above, the lid 20 conforms to the ring 10 and couples the primary lid 20 to the container 5 by force fitting groove 22 into cooperating groove 12 on the ring 10, as well as by clamping the axially aligned edge section to the top and bottom axial surfaces of edge 111 (i.e., the beverage can coupling). Given this arrangement, it is important for the axial elevation of the lid portion 21 to have a radial ledge aligned along axis A and to terminate at or below axis B (i.e., the snap-fitting feature or curled section at the edge 211 of primary lid 20 descends below axis B). Further, the inner diameter on the axial section on the lid 20 that fits around the curled combination of container 5 and edge 111 must be greater than the outer diameter of combination, while the groove 22 must drop down at or immediately adjacent to axis D and create an interference fit within both axial surfaces defining groove 12 on the ring (more preferably, the bottom U-shape of the groove 22 also comes into contact with the radially aligned surface in the groove 12).

Coaxially inset from the groove section 22 on the lid 20, a ridge 25 defines a pocket that receives and couples to curled section 13 on the ring 10. Ridge 25 includes an angled wall section 242 that may be resilient to conform and seal to the curled section 13. In turn, angled wall 242 terminates at or slightly below axis C, which aligns with the positioning of the panel 24. Axis C will have a lower axial elevation in comparison to axis B. Conversely, the ridge 25 will have its maximum axial height above axis B but below (or possibly coinciding with) axis A.

Along its inner most portion, the primary lid 20 includes a centrally located flat closure panel 24. This panel will seal the contents of the container and prevent unwanted leakage, evaporation, or loss of the container's contents.

Flat panel 24 includes a removable sealing panel that may be defined by thinned and/or indented groove 241. Groove 241 is positioned concentrically within the perimeter defined by the inner edge 13 of the crimp ring 10, and the depth/axial elevation of groove 241 descending below axis C (which, itself is aligned in the same plane as a central portion of the flat panel 24).

Panel 24 and/or the removable section defined by groove 241 is preferably circular and positioned immediately adjacent to the angled wall 242; however, teardrop-shaped, polygonal or other functional shapes that do not otherwise conform to the circular shape of the ring 10 and ridge 25 are possible. These functional shapes can facilitate insertion of a paint brush and/or facilitate pouring. Pulling bails 26 may be provided to further simplify the removal of at least portions of panel 24. The panel serves as a form of tamper evidence, in addition to providing a second seal (in combination with the cap that is coupled to the insert).

Panel 24 is essentially a “peelable feature” similar to a soup can or Spam can. The panel 24 may be formed by thinned groove sections (formed by stamping, etching, etc.), perforations, or other similar means that conform to the groove 241 indicated in FIG. 1. In a preferred aspect, the removable panel has a circular shape that abuts the inner-most contact point between the curled edge of the crimp ring and the primary lid, so as to maximize the open area of the closure system when the secondary lid is removed.

Notably, the angled wall section 242 provides strength and resilience to facilitate the removal of panel 24. That is, the angle of the wall slopes, rather being aligned parallel to the corresponding walls of groove 22. In this manner, angled wall section 242 imparts flexibility needed to accomplish the aims of the inventive system, as does the specific arrangement and comparative axial elevations of the components of the lid 20 relative to the ring 10, as shown in FIG. 1.

A secondary lid 30 is removable held within the features on the top facing of the primary lid. The secondary lid 30 will preferably have a smaller outer diameter than either the primary lid 20 or the crimp ring 10. The purpose of this secondary lid 30 is to allow for the container to be opened and resealed multiple times. In this manner, tamper evidence is achieved (via the primary lid) while the user retains the familiar closure features found on conventional paint cans.

The secondary lid 30 may include a curled edge 31 serving as an attachment feature along its outer periphery. This curled edge 31 also provides a “stop” to prevent the annular groove 32 on the secondary lid 30 from becoming wedged too tightly within the groove 22 of the primary lid 20. As noted above, these grooves may have cooperating U-shapes, although a ridge or other shape may be included or substituted, so long as all three coupling features (on the crimp ring, primary lid, and secondary lid) are similarly shaped. Also, as noted above, the fit between any two of these components should create intimate contact along the two axially aligned surfaces defining the respective groove, although a third point of contact at the lower most axial interface is also possible.

The central portion 34 of the secondary lid 30 is a flat panel that seals the opening formed when the removable panel 24 of the primary lid 20 is displaced. Portion 34 may be surrounded by a groove 341 that conforms to the corresponding surfaces on the top of lid 20; however, groove 341 could be replace or augmented with additional features. For example, sealing skirt 35 could extend from an underside of the solid panel 34, while possessing a shape, diameter, and axial extension to engage and seal the opening that will be created when panel 24 is removed so that skirt 35 forms a plug seal with the ridge 25, angled wall section 242, and/or exposed edge of the groove 241 after the frangible section of panel 24 is removed. Skirt 35 and the solid central portion of the lid 30 can be formed from plastic, metal, or a metal disk overmolded by a plastic periphery.

In the alternative arrangements depicted in FIG. 4, curled edge 31 can be replaced by a larger diameter, C-shaped snap-fitting 36. Here, a radial bead 361 is positioned at the end skirt/sidewall 362, so as to coaxially receive and snap-fit over and around the outer edge 211. In this arrangement groove 32 is also removed.

The secondary lid 30 may be made from the same materials as the crimp ring and/or primary lid. However, in various aspects, the secondary lid 30 may be made partially or completely from plastic, so as to allow for potential cost savings. The use of plastic may also enable and enhance the ability to rely on plug sealing features 35 and snap-fitting features 36, as shown in FIG. 4. Specifically, features 35 have dimensions to cooperate and seal to similar features on other items (e.g., the inner and/or outer diameter(s) of a container neck or opening), with preferred aspects constituting an axially extending lip or ridge on the underside of the lid 30. In some arrangements, portions or the entirety of lid 20 could be formed from plastic or a metal disk over-molded with a plastic periphery, although any plastic used as part of lid 20 must be sufficient workable to create and conform to the shapes and coupling arrangements contemplated herein.

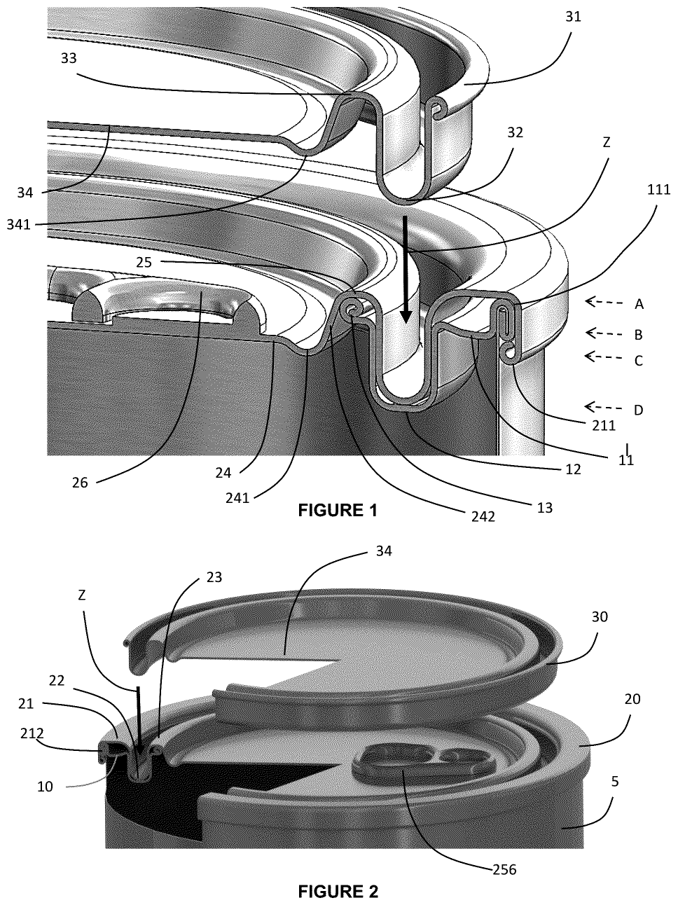

The secondary lid 30 serves as the resealable lid once the peelable feature is removed. The product would be sold as a “double lid” package. The formed beads on the lids would be configured to properly fit together. In the arrangement of FIGS. 1 and 2, secondary lid 30 may be metallic, and its use provides added level of sealing and protection for the product. It should be noted that the removable panel 24 effectively acts as a tamper evident feature which, because it is concealed by lid 30, should be particularly effective. A frangible ring, tear strip, or other TE feature similar to those described in the background above could be provided on secondary lid 30, and particularly the aspects contemplated in FIG. 4.

The secondary lid 30 can also be made of all plastic in an appropriate material suitable for paint, varnishes, and other chemicals or solvents. The plastic lid can be configured with a seal to match the “cut-out” in the primary lid. Additionally or alternatively, the lid 30 can be made of a combination of metal and plastic. The metal portion would act as the seal in the open area and the plastic would wrap around and over the can rim to secure it. The metal portions could be overmolded for a secure fit. In the same manner, the removable panel 24 in lid 20 could be made with a similar construction.

The foregoing concepts offer a high degree of product resistance and compatibility with many solvent-based paints and varnishes. The dual lid arrangement allows for sealing and tamper evidence (via the primary lid). The secondary lid allows the system to be resealed quickly and easily.

The system, in all of its various forms, is suited for attachment to standard sized paint containers, including those having a nominal inner diameter of 3.150 inches. In some aspects, the system is designed to have an inner diameter of 3.472 inches, although the means for attaching the crimp ring and insert are fully compatible with existing/standard container closing methods. In fact, the insert and/or primary lid could crimped to the sidewall portion using the same machinery and methods as employed with existing technologies.

As noted above, the system as contemplated and described provides for two separate hermetic seals of the container when it is initially shipped. Owing to the removable panel on the primary lid, an end user has tamper evidence and, owing to the secondary lid, the ability to open and reseal the container. Further still, the secondary lid may take on the familiar engagement mechanism found on many existing paint containers (i.e., a rim-seal in which the grooves create a releasable interference fit) and/or by providing a snap-fitting skirt. Finally, the configurations herein allow for the use of plastic components in either of these arrangements (rim-seal or snap-fitting skirt), which may create benefits in terms of materials compatibility and costs, especially to the extent the liquid in the container might otherwise require specialized alloys and/or a coating to protect metallic components from corrosion.

In view of the foregoing, the invention includes a variety of different aspects. For example, the tamper-evident closure system for cylindrical paint containers, the system can include an annular ring having an outer peripheral edge configured for attachment by way of crimping, an inner peripheral edge, and a mid-section including an engagement groove and radial ledge; a primary lid seated on a top facing of the annular ring, the primary lid having a central portion with a tamper evident panel defined by a thinned groove formed in the central portion, a peripheral edge that couples to the outer peripheral edge of the annular ring, and middle portion positioned between the central portion and the peripheral edge of the primary lid and including a ridge and a groove configured to be seated within the groove of the annular ring; and a secondary lid seated on a top facing of the primary lid, the secondary lid having an attachment feature on its peripheral edge and a solid panel that covers and seals the central portion of the primary lid. In these aspect, both the primary and secondary lid seal create a seal over an opening in the annular ring prior to removal of the tamper evident panel and the axial elevation of the tamper evident panel is: i) above that of both the thinned groove and a lower extremity of the groove in the primary lid, and ii) below that of the mid-section of the annular ring. Additionally, further aspects may include any one or combination of the following features:
wherein the peripheral edge of the primary lid has an outer diameter that is larger than an outer diameter of the outer peripheral edge of the annular ring;
wherein an angled wall in the primary lid attaches the ridge to the central portion;
wherein the thinned groove defines a circular shape that is formed immediately adjacent to and concentrically within the middle portion of the primary lid;
wherein the thinned groove has a teardrop shape;
wherein the tamper evident panel includes a pulling handle that is concealed by the secondary lid;
wherein the peripheral edge of the primary lid couples to the annular ring by curling beneath the outer peripheral edge of the annular ring at an axial elevation that is beneath that of the mid-section of the annular ring;
wherein the secondary lid includes a sealing skirt positioned on a bottom facing of the solid panel;
wherein the attachment feature of the secondary lid includes a peripheral skirt and a radial bead that snap fits over the peripheral edge of the primary lid so that the radial bead is positioned at an axial elevation that is completely beneath the peripheral edge of the primary lid;
wherein the attachment feature of the secondary lid includes a groove configured to be seated within the groove of the primary lid; and
wherein the solid panel of the secondary lid comprises a metallic overmolded with a plastic periphery.

All components should be made of materials having sufficient flexibility and structural integrity, as well as a chemically inert nature. The materials should also be selected for workability, cost, and weight. In addition to the materials specifically noted above, common polymers amenable to injection molding, extrusion, or other common forming processes should have particular utility, although metals, alloys, and other composites may be used in place of or in addition to more conventional materials. Various grades of low density polyethylene may have particular utility in view of the design goals and requirements noted above.

References to coupling are to be understood as encompassing any of the conventional means used in this field. This may take the form of snap- or force fitting of components, although threaded connections, bead-and-groove, “beverage can” and other forms of crimping, and bayonet-style/slot-and-flange assemblies could be employed. Adhesive and fasteners could also be used, although such components must be judiciously selected so as to retain the functionality of the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

References sealing or being in a sealed state means that interfacing components are in sufficient and intimate contact to prevent unwanted fluid flow across that interface. These fluids may be liquid (e.g., dispensed fluids) or gaseous (e.g., ambient air). These seals can be temporary, as may be the case with the removable caps, so that the interfacing surfaces are capable of sliding over/across one another. In other instances, the seal is intended to be permanent, so that the aforementioned coupling arrangements or force fittings created by a “plug seal” arrangement (in which an edge or flange is forced fitted into a gap on the other component) are effective and appropriate. In the drawings, it will be understood that sealing features are or may need to be employed, particularly in those areas where a non-linear interface appears.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof

What is claimed is:

1. A tamper-evident closure system for cylindrical paint containers, the system comprising:
an annular ring having an outer peripheral edge configured for attachment by way of crimping, an inner peripheral edge, and a mid-section including an engagement groove and radial ledge;
a primary lid seated on a top facing of the annular ring, the primary lid having a central portion with a tamper evident panel defined by a thinned groove formed in the central portion, a peripheral edge that couples to the outer peripheral edge of the annular ring, and middle portion positioned between the central portion and the peripheral edge of the primary lid and including a ridge and a groove configured to be seated within the groove of the annular ring;
a secondary lid seated on a top facing of the primary lid, the secondary lid having an attachment feature on its peripheral edge and a solid panel that covers and seals the central portion of the primary lid; and
wherein, prior to removal of the tamper evident panel, both the primary and secondary lid seal create a seal over an opening in the annular ring and wherein an axial elevation of the tamper evident panel is: i) above that of both the thinned groove and a lower extremity of the groove in the primary lid, and ii) below that of the mid-section of the annular ring.

2. The system of claim 1 wherein the peripheral edge of the primary lid has an outer diameter that is larger than an outer diameter of the outer peripheral edge of the annular ring.

3. The system of claim 1 wherein an angled wall in the primary lid attaches the ridge to the central portion.

4. The system of claim 1 wherein the thinned groove defines a circular shape that is formed immediately adjacent to and concentrically within the middle portion of the primary lid.

5. The system of claim 1 wherein the thinned groove has a teardrop shape.

6. The system of claim 1 wherein the tamper evident panel includes a pulling handle that is concealed by the secondary lid.

7. The system of claim 1 wherein the peripheral edge of the primary lid couples to the annular ring by curling beneath the outer peripheral edge of the annular ring at an axial elevation that is beneath that of the mid-section of the annular ring.

8. The system of claim 1 wherein the secondary lid includes a sealing skirt positioned on a bottom facing of the solid panel.

9. The system of claim 1 wherein the attachment feature of the secondary lid includes a peripheral skirt and a radial bead that snap fits over the peripheral edge of the primary lid so that the radial bead is positioned at an axial elevation that is completely beneath the peripheral edge of the primary lid.

10. The system of claim 1 wherein the attachment feature of the secondary lid includes a groove configured to be seated within the groove of the primary lid.

11. The system of claim 1 wherein the solid panel of the secondary lid comprises a metallic overmolded with a plastic periphery.
